(19) United States
(12) Patent Application Publication
(10) Pub. No.: US 2017/0097962 A1
(43) Pub. Date: Apr. 6, 2017

(54) TOPIC MINING METHOD AND APPARATUS

(71) Applicant: Huawei Technologies Co., Ltd., Shenzhen (CN)

(72) Inventors: Jia Zeng, Hong Kong (CN); Mingxuan Yuan, Hong Kong (CN); Shiming Zhang, Shenzhen (CN)

(21) Appl. No.: 15/383,606

(22) Filed: Dec. 19, 2016

Related U.S. Application Data
(63) Continuation of application No. PCT/CN2015/081897, filed on Jun. 19, 2015.

(30) Foreign Application Priority Data
Jun. 20, 2014 (CN) 201410281183.9

(51) Int. Cl. G06F 17/30; G06N 99/00; G06F 17/16

(52) U.S. Cl. CPC G06F 17/30539; G06F 17/30011; G06F 17/30324; G06F 17/16; G06N 99/005

(57) ABSTRACT

A topic mining method and apparatus are disclosed. When an iterative process is executed each time, an object message vector is determined from a message vector according to a residual of the message vector, so that a current document-topic matrix and a current term-topic matrix are updated according to only the object message vector, and then calculation is performed, according to the current document-topic matrix and the current term-topic matrix, on only an object element that is in the term-document matrix and that corresponds to the object message vector, thereby avoiding that in each iterative process, calculation needs to be performed on all non-zero elements in the term-document matrix, and avoiding that the current document-topic matrix and the current term-topic matrix are updated according to all message vectors, which greatly reduces an operation amount, increases a speed of topic mining, and increases efficiency of topic mining.

### CROSS-REFERENCE TO RELATED APPLICATION

This application is a continuation of International Application No. PCT/CN2015/081897, filed on Jun. 19, 2015, which claims priority to Chinese Patent Application No. 201410281183.9, filed on Jun. 20, 2014, the disclosures of the aforementioned applications are hereby incorporated by reference in their entireties.

### TECHNICAL FIELD

Embodiments of the present invention relate to information technologies, and in particular, to a topic mining method and apparatus.

### BACKGROUND

Topic mining is a process of clustering, in a large-scale document set, semantically related terms by using a latent Dirichlet allocation (LDA) model that is a machine learning model, so that a topic of each document in the large-scale document set is obtained in a probability distribution form, where the topic is a theme expressed by an author by means of the document.

In topic mining in the prior art, first an LDA model needs to be trained by using a belief propagation (BP) algorithm and based on a training document, to determine model parameters, that is, a term-topic matrix Φ and a document-topic matrix θ, of the trained LDA model; and a term-document matrix of a document to be tested is then entered into the trained LDA model to perform topic mining, so as to obtain a document-topic matrix θ′ that is used to indicate topic allocation of the document to be tested. The BP algorithm includes a large amount of iterative calculation, that is, repeatedly executes a process of calculating each non-zero element in a term-document matrix according to a current document-topic matrix and a current term-topic matrix that are of an LDA model, to obtain a message vector of each non-zero element in the term-document matrix, and then updating the current document-topic matrix and the current term-topic matrix according to all the message vectors, until the message vector, the current document-topic matrix, and the current term-topic matrix enter a convergence state. In each iterative process, the message vector needs to be calculated for each non-zero element in the term-document matrix, and the current document-topic matrix and the current term-topic matrix need to be updated according to all the message vectors. Therefore, a calculation amount is relatively large, resulting in relatively low efficiency of topic mining, and an existing topic mining method is applicable only when the term-document matrix is a discrete bag-of-words matrix.

### SUMMARY

Embodiments of the present invention provide a topic mining method and apparatus, to reduce an operation amount of topic mining and increase efficiency of topic mining.

An aspect of the embodiments of the present invention provides a topic mining method, including:

performing calculation on a non-zero element in a term-document matrix of a training document according to a current document-topic matrix and a current term-topic matrix of a latent Dirichlet allocation LDA model, to obtain a message vector Mₙ of the non-zero element; determining an object message vector ObjectMₙ from the message vector Mₙ of the non-zero element according to a residual of the message vector of the non-zero element, where the object message vector is a message vector that ranks in a top preset proportion in descending order of residuals, and a value range of the preset proportion is less than 1 and greater than 0; updating the current document-topic matrix and the current term-topic matrix of the LDA model according to the object message vector ObjectMₙ; determining, from the non-zero element in the term-document matrix, an object element ObjectEₙ corresponding to the object message vector ObjectMₙ; executing, for an (n+1)^{th} time, an iterative process of performing calculation on the object element ObjectEₙ determined for an n^{th} time in the term-document matrix of the training document according to the current document-topic matrix and the current term-topic matrix of the LDA model, to obtain a message vector Mₙ₊₁ of the object element ObjectEₙ determined for the n^{th} time in the term-document matrix, determining, according to a residual of the message vector of the object element determined for the n^{th} time, an object message vector ObjectMₙ₊₁ from the message vector Mₙ₊₁ of the object element ObjectEₙ determined for the n^{th} time, updating the current document-topic matrix and the current term-topic matrix according to the object message vector ObjectMₙ₊₁ determined for the (n+1)^{th} time, and determining, from the term-document matrix, an object element ObjectEₙ₊₁ corresponding to the object message vector ObjectMₙ₊₁ determined for the (n+1)^{th} time, until a message vector, a current document-topic matrix, and a current term-topic matrix of an object element ObjectEₚ after the screening enter a convergence state; and determining the current document-topic matrix that enters the convergence state and the current term-topic matrix that enters the convergence state as parameters of the LDA model, and performing, by using the LDA model whose parameters have been determined, topic mining on a document to be tested.

In a first possible implementation manner of the first aspect, the determining an object message vector ObjectMₙ from the message vector Mₙ of the non-zero element according to a residual of the message vector of the non-zero element includes: calculating the residual of the message vector of the non-zero element; querying, in descending order, the residual obtained by means of calculation for an object residual that ranks in the top preset proportion, where the preset proportion is determined according to efficiency of topic mining and accuracy of a result of the topic mining; and determining the object message vector ObjectMₙ corresponding to the object residual from the message vector Mₙ of the non-zero element.

With reference to the first possible implementation manner of the first aspect, in a second possible implementation manner of the first aspect, the calculating the residual of the message vector of the non-zero element includes: calculating the residual of the message vector of the non-zero element according to a formula r_{w,d}ⁿ(k)=x_{w,d}|μ_{w,d}ⁿ(k)−μ_{w,d}ⁿ⁻¹(k)|, where r_{w,d}ⁿ(k) is the residual of the message vector of the non-zero element, k=1, 2, . . . , K, K is a preset quantity of topics, μ_{w,d}ⁿ(k) is a value of a k^{th} element of a message vector obtained by performing, in the iterative process executed for the n^{th} time, calculation on an element in a w^{th} row and a d^{th} column in the term-document matrix, x_{w,d} is a value of the element in the w^{th} row and the d^{th} column in the term-document matrix, and μ_{w,d}ⁿ⁻¹ is a value of a k^{th} element of a message vector obtained by performing, in the iterative process executed for an (n−1)^{th} time, calculation on the element in the w^{th} row and the d^{th} column in the term-document matrix.

With reference to the first possible implementation manner of the first aspect or the second possible implementation manner of the first aspect, in a third possible implementation manner of the first aspect, the querying, in descending order, the residual obtained by means of calculation for an object residual that ranks in the top preset proportion includes: performing calculation on the residual r_{w,d}ⁿ(k) according to a formula

$${r}_{w}^{n} ( k ) = {\sum }_{d} {r}_{w , d}^{n} ( k ) ,$$

to obtain a cumulative residual matrix, where r_{w,d}ⁿ(k) is a value of a k^{th} element, in the iterative process executed for the n^{th} time, of a residual of the message vector of the element in the w^{th} row and the d^{th} column in the term-document matrix, and r_{w}ⁿ(k) is a value of an element, in the iterative process executed for the n^{th} time, in a w^{th} row and a k^{th} column in the cumulative residual matrix; in each row in the cumulative residual matrix, determining, in descending order, a column ρ_{w}ⁿ(k) in which an element that ranks in the top preset proportion λₖ is located, where 0<λₖ≦1; accumulating the element determined in each row, to obtain a sum value corresponding to each row; determining a row ρ_{w}ⁿ corresponding to a sum value that ranks in the top preset proportion λ_{w} in descending order, where 0<λ_{w}≦1, and λₖ×λ_{w}≠1; and determining a residual r_{ρ}_{_{w}}_{ⁿ}_{,d}ⁿ(ρ_{w}ⁿ(k)) that meets k=ρ_{w}ⁿ(k), w=ρ_{w}ⁿ as the object residual.

With reference to the third possible implementation manner of the first aspect, in a fourth possible implementation manner of the first aspect, the determining the object message vector ObjectMₙ corresponding to the object residual from the message vector Mₙ of the non-zero element includes: determining, from the message vector Mₙ of the non-zero element, the object message vector ObjectMₙ corresponding to the object residual r_{ρ}_{_{w}}_{ⁿ}_{,d}ⁿ(ρ_{w}ⁿ(k)) as μₚ_{_{w}}_{ⁿ}_{,d}ⁿ(ρ_{w}ⁿ(k)).

With reference to the second possible implementation manner of the first aspect, the third possible implementation manner of the first aspect or the fourth possible implementation manner of the first aspect, in a fifth possible implementation manner of the first aspect, the updating the current document-topic matrix and the current term-topic matrix of the LDA model according to the object message vector ObjectMₙ includes:

performing calculation according to a formula

$${θ}_{d}^{n} ( k ) = {\sum }_{w} {x}_{w , d} {μ}_{w , d}^{n} ( k ) ,$$

to obtain a value θ_{d}ⁿ(k) of an element in a k^{th} row and a d^{th} column in an updated current document-topic matrix of the LDA model, and updating a value of an element in a k^{th} row and a d^{th} column in the current document-topic matrix of the LDA model by using θ_{d}ⁿ(k), where k=1, 2, . . . , K, K is a preset quantity of topics, x_{w,d} is a value of the element in the w^{th} row and the d^{th} column in the term-document matrix, and μ_{w,d}ⁿ(k) is a value of the k^{th} element of the message vector obtained by performing, in the iterative process executed for the n^{th} time, calculation on x_{w,d}; and obtaining, by means of calculation according to a formula

$${Φ}_{w}^{n} ( k ) = {\sum }_{d} {x}_{w , d} {μ}_{w , d}^{n} ( k ) {μ}_{w , d}^{n} ( k ) ,$$

a value Φ_{w}ⁿ(k) of an element in a k^{th} row and a w^{th} column in an updated current term-topic matrix of the LDA model, and updating a value of an element in a k^{th} row and a w^{th} column in the current term-topic matrix of the LDA model by using Φ_{w}ⁿ(k).

With reference to the first aspect, the first possible implementation manner of the first aspect, the second possible implementation manner of the first aspect, the third possible implementation manner of the first aspect or the fourth possible implementation manner of the first aspect, in a sixth possible implementation manner of the first aspect, the performing calculation on a non-zero element in a term-document matrix of a training document according to a current document-topic matrix and a current term-topic matrix of a latent Dirichlet allocation LDA model, to obtain a message vector Mₙ of the non-zero element includes: in the iterative process executed for the n^{th} time, performing calculation according to a formula

$${μ}_{w , d}^{n} ( k ) ∝ \frac{[ {θ}_{d}^{n - 1} ( k ) + α ] \times [ {Φ}_{w}^{n - 1} ( k ) + β ]}{{\sum }_{w} {Φ}_{w}^{n - 1} ( k ) + w β} ,$$

to obtain a value μ_{w,d}ⁿ(k) of a k^{th} element of the message vector of the element x_{w,d} in the w^{th} row and the d^{th} column in the term-document matrix, where k=1, 2, . . . , K, K is a preset quantity of topics, w=1, 2, . . . , W, W is a length of a term list, d=1, 2, . . . , D, D is a quantity of the training documents, θ_{d}ⁿ(k) is a value of an element in a k^{th} row and a d^{th} column in the current document-topic matrix, Φ_{w}ⁿ(k) is a value of an element in a k^{th} row and a w^{th} column in the current term-topic matrix, and α and β are preset coefficients whose value ranges are positive numbers.

With reference to the first aspect, the first possible implementation manner of the first aspect, the second possible implementation manner of the first aspect, the third possible implementation manner of the first aspect or the fourth possible implementation manner of the first aspect, in a seventh possible implementation manner of the first aspect, before the performing calculation on a non-zero element in a term-document matrix of a training document according to a current document-topic matrix and a current term-topic matrix of a latent Dirichlet allocation LDA model, to obtain a message vector Mₙ of the non-zero element, the method further includes: determining an initial message vector μ_{w,d}⁰(k) of each non-zero element in the term-document matrix, where k=1, 2, . . . , K, K is a preset quantity of topics,

$${\sum }_{k} {μ}_{w , d}^{0} ( k ) = 1 ,$$

and μ_{w,d}⁰(k)≧0, where μ_{w,d}⁰(k) is a k^{th} element of the initial message vector of the non-zero element x_{w,d} in the w^{th} row and the d^{th} column in the term-document matrix; calculating the current document-topic matrix according to a formula

$${θ}_{d}^{0} ( k ) = {\sum }_{w} {x}_{w , d} {μ}_{w , d}^{0} ( k ) ,$$

where μ_{w,d}⁰(k) is the initial message vector, and θ_{d}⁰(k) is a value of an element in a k^{th} row and a d^{th} column in the current document-topic matrix; and calculating the current term-topic matrix according to a formula

$${Φ}_{w}^{0} ( k ) = {\sum }_{d} {x}_{w , d} {μ}_{w , d}^{0} ( k ) ,$$

where μ_{w,d}⁰(k) is the initial message vector, and Φ_{w}⁰(k) is a value of an element in a k^{th} row and a w^{th} column in the current term-topic matrix.

A second aspect of embodiments of the present invention provides a topic mining apparatus, including:

a message vector calculation module, configured to perform calculation on a non-zero element in a term-document matrix of a training document according to a current document-topic matrix and a current term-topic matrix of a latent Dirichlet allocation LDA model, to obtain a message vector Mₙ of the non-zero element; a first screening module, configured to determine an object message vector ObjectMₙ from the message vector Mₙ of the non-zero element according to a residual of the message vector of the non-zero element, where the object message vector is a message vector that ranks in a top preset proportion in descending order of residuals, and a value range of the preset proportion is less than 1 and greater than 0; an update module, configured to update the current document-topic matrix and the current term-topic matrix of the LDA model according to the object message vector ObjectMₙ; a second screening module, configured to determine, from the non-zero element in the term-document matrix, an object element ObjectEₙ corresponding to the object message vector ObjectMₙ; an execution module, configured to execute, for an (n+1)^{th} time, an iterative process of performing calculation on the object element ObjectEₙ determined for an n^{th} time in the term-document matrix of the training document according to the current document-topic matrix and the current term-topic matrix of the LDA model, to obtain a message vector Mₙ₊₁ of the object element ObjectEₙ determined for the n^{th} time in the term-document matrix, determining, according to a residual of the message vector of the object element determined for the n^{th} time, an object message vector ObjectMₙ₊₁ from the message vector Mₙ₊₁ of the object element ObjectEₙ determined for the n^{th} time, updating the current document-topic matrix and the current term-topic matrix according to the object message vector ObjectMₙ₊₁ determined for the (n+1)^{th} time, and determining, from the term-document matrix, an object element ObjectEₙ₊₁ corresponding to the object message vector ObjectMₙ₊₁ determined for the (n+1)^{th} time, until a message vector, a current document-topic matrix, and a current term-topic matrix of an object element ObjectEₚ after the screening enter a convergence state; and a topic mining module, configured to determine the current document-topic matrix that enters the convergence state and the current term-topic matrix that enters the convergence state as parameters of the LDA model, and perform, by using the LDA model whose parameters have been determined, topic mining on a document to be tested.

In a first possible implementation manner of the second aspect, the first screening module includes: a calculation unit, configured to calculate the residual of the message vector of the non-zero element; a query unit, configured to query, in descending order, the residual obtained by means of calculation for an object residual that ranks in the top preset proportion, where the preset proportion is determined according to efficiency of topic mining and accuracy of a result of the topic mining; and a screening unit, configured to determine the object message vector ObjectMₙ corresponding to the object residual from the message vector Mₙ of the non-zero element.

With reference to the first possible implementation manner of the second aspect, in a second possible implementation manner of the second aspect, the calculation unit is specifically configured to calculate the residual of the message vector of the non-zero element according to a formula r_{w,d}ⁿ(k)=x_{w,d}|μ_{w,d}ⁿ(k)−μ_{w,d}ⁿ⁻¹(k)|, where r_{w,d}ⁿ(k) is the residual of the message vector of the non-zero element, k=1, 2, . . . , K, K is a preset quantity of topics, μ_{w,d}ⁿ(k) is a value of a k^{th} element of a message vector obtained by performing, in the iterative process executed for the n^{th} time, calculation on an element in a w^{th} row and a d^{th} column in the term-document matrix, x_{w,d} is a value of the element in the w^{th} row and the d^{th} column in the term-document matrix, and μ_{w,d}ⁿ⁻¹(k) is a value of a k^{th} element of a message vector obtained by performing, in the iterative process executed for an (n−1)^{th} time, calculation on the element in the w^{th} row and the d^{th} column in the term-document matrix.

With reference to the first possible implementation manner of the second aspect or the second possible implementation manner of the second aspect, in a third possible implementation manner of the second aspect, the query unit is specifically configured to perform calculation on the residual r_{w,d}ⁿ(k) according to a formula

$${r}_{w}^{n} ( k ) = {\sum }_{d} {r}_{w , d}^{n} ( k ) ,$$

to obtain a cumulative residual matrix, where r_{w,d}ⁿ(k) is a value of a k^{th} element, in the iterative process executed for the n^{th} time, of a residual of the message vector of the element in the w^{th} row and the d^{th} column in the term-document matrix, and r_{w}ⁿ(k) is a value of an element, in the iterative process executed for the n^{th} time, in a w^{th} row and a k^{th} column in the cumulative residual matrix; in each row in the cumulative residual matrix, determine, in descending order, a column ρ_{w}ⁿ(k) in which an element that ranks in the top preset proportion λₖ is located, where 0<λₖ≦1; accumulate the element determined in each row, to obtain a sum value corresponding to each row; determine a row ρ_{w}ⁿ corresponding to a sum value that ranks in the top preset proportion λ_{w} in descending order, where 0<λ_{w}≦1, and λₖ×λ_{w}≠1; and determine a residual r_{ρ}_{_{w}}_{ⁿ}_{,d}ⁿ(ρ_{w}ⁿ(k)) that meets k=ρ_{w}ⁿ(k), w=ρ_{w}ⁿ as the object residual.

With reference to the third possible implementation manner of the second aspect, in a fourth possible implementation manner of the second aspect, the screening unit is specifically configured to determine, from the message vector Mₙ of the non-zero element, the object message vector ObjectMₙ corresponding to the object residual r_{ρ}_{_{w}}_{ⁿ}_{,d}ⁿ(ρ_{w}ⁿ(k)) as μₚ_{_{w}}_{ⁿ}_{,d}ⁿ(ρ_{w}ⁿ(k)).

With reference to the second possible implementation manner of the second aspect, the third possible implementation manner of the second aspect or the fourth possible implementation manner of the second aspect, in a fifth possible implementation manner of the second aspect, the update module includes: a first update unit, configured to perform calculation according to a formula

$${θ}_{d}^{n} ( k ) = {\sum }_{w} {x}_{w , d} {μ}_{w , d}^{n} ( k ) ,$$

to obtain a value θ_{d}ⁿ(k) of an element in a k^{th} row and a d^{th} column in an updated current document-topic matrix of the LDA model, and update a value of an element in a k^{th} row and a d^{th} column in the current document-topic matrix of the LDA model by using θ_{d}ⁿ(k) where k=1, 2, . . . , K, K is a preset quantity of topics, x_{w,d} is a value of the element in the w^{th} row and the d^{th} column in the term-document matrix, and μ_{w,d}ⁿ(k) is a value of the k^{th} element of the message vector obtained by performing, in the iterative process executed for the n^{th} time, calculation on x_{w,d}; and a second update unit, configured to obtain by means of calculation, according to a formula

$${Φ}_{w}^{n} ( k ) = {\sum }_{d} {x}_{w , d} {μ}_{w , d}^{n} ( k ) {μ}_{w , d}^{n} ( k ) ,$$

a value Φ_{w}ⁿ(k) of an element in a k^{th} row and a w^{th} column in an updated current term-topic matrix of the LDA model, and update a value of an element in a k^{th} row and a w^{th} column in the current term-topic matrix of the LDA model by using Φ_{w}ⁿ(k).

With reference to the second aspect, the first possible implementation manner of the second aspect, the second possible implementation manner of the second aspect, the third possible implementation manner of the second aspect or the fourth possible implementation manner of the second aspect, in a sixth possible implementation manner of the second aspect, the message vector calculation module is specifically configured to: in the iterative process executed for the n^{th} time, perform calculation according to a formula

$${μ}_{w , d}^{n} ( k ) ∝ \frac{[ {θ}_{d}^{n - 1} ( k ) + α ] \times [ {Φ}_{w}^{n - 1} ( k ) + β ]}{{\sum }_{w} {Φ}_{w}^{n - 1} ( k ) + w β} ,$$

to obtain a value μ_{w,d}ⁿ(k) of an k^{th} element of the message vector of the element x_{w,d} in the w^{th} row and the d^{th} column in the term-document matrix, where k=1, 2, . . . , K, K is a preset quantity of topics, w=1, 2, . . . , W, W is a length of a term list, d=1, 2, . . . , D, D is a quantity of the training documents, θ_{d}ⁿ(k) is a value of an element in a k^{th} row and a d^{th} column in the current document-topic matrix, Φ_{w}ⁿ(k) is a value of an element in a k^{th} row and a w^{th} column in the current term-topic matrix, and α and β are preset coefficients whose value ranges are positive numbers.

With reference to the second aspect, the first possible implementation manner of the second aspect, the second possible implementation manner of the second aspect, the third possible implementation manner of the second aspect or the fourth possible implementation manner of the second aspect, in a seventh possible implementation manner of the second aspect, the apparatus further includes: a determining module, configured to determine an initial message vector μ_{w,d}⁰(k) of each non-zero element in the term-document matrix, where k=1, 2, . . . , K, K is a preset quantity of topics,

$${\sum }_{k} {μ}_{w , d}^{0} ( k ) = 1 ,$$

and μ_{w,d}⁰(k)≧0, where μ_{w,d}⁰(k) is a k^{th} element of the initial message vector of the non-zero element x_{w,d} in the w^{th} row and the d^{th} column in the term-document matrix; a first obtaining module, configured to calculate the current document-topic matrix according to a formula

$${θ}_{d}^{0} ( k ) = {\sum }_{w} {x}_{w , d} {μ}_{w , d}^{0} ( k ) ,$$

where μ_{w,d}⁰(k) is the initial message vector, and θ_{d}(k) is a value of an element in a k^{th} row and a d^{th} column in the current document-topic matrix; and a second obtaining module, configured to calculate the current term-topic matrix according to a formula

$${Φ}_{w}^{0} ( k ) = {\sum }_{d} {x}_{w , d} {μ}_{w , d}^{0} ( k ) ,$$

where μ_{w,d}⁰(k) is the initial message vector, and Φ_{w}⁰(k) is a value of an element in a k^{th} row and a w^{th} column in the current term-topic matrix.

Be means of the topic mining method and apparatus that are provided in the embodiments of the present invention, when an iterative process is executed each time, an object message vector is determined from a message vector according to a residual of the message vector, and then a current document-topic matrix and a current term-topic matrix are updated according to only an object message vector that is determined by executing the iterative process at a current time, so that when the iterative process is executed subsequently, calculation is performed, according to the current document-topic matrix and the current term-topic matrix, on an object element that is in the term-document matrix and that corresponds to the object message vector determined by executing the iterative process at a previous time, thereby avoiding that in each iterative process, calculation needs to be performed on all non-zero elements in the term-document matrix, and avoiding that the current document-topic matrix and the current term-topic matrix are updated according to all message vectors, which greatly reduces an operation amount, increases a speed of topic mining, and increases efficiency of topic mining.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following description show some embodiments of the present invention, and persons of ordinary skill in the art may still derive other drawings from these accompanying drawings without creative efforts.

FIG. 1 is a schematic flowchart of a topic mining method according to an embodiment of the present invention;

FIG. 2 is a schematic flowchart of a topic mining method according to another embodiment of the present invention;

FIG. 3 is a schematic structural diagram of a topic mining apparatus according to an embodiment of the present invention;

FIG. 4 is a schematic structural diagram of a topic mining apparatus according to another embodiment of the present invention;

FIG. 5 is a schematic structural diagram of a topic mining apparatus according to still another embodiment of the present invention; and

FIG. 6 is an architecture diagram in which a topic mining apparatus is applied to online public opinion analysis.

### DETAILED DESCRIPTION

To make the objectives, technical solutions, and advantages of the embodiments of the present invention clearer, the following clearly describes the technical solutions in the embodiments of the present invention with reference to the accompanying drawings in the embodiments of the present invention. Apparently, the described embodiments are some but not all of the embodiments of the present invention. All other embodiments obtained by persons of ordinary skill in the art based on the embodiments of the present invention without creative efforts shall fall within the protection scope of the present invention.

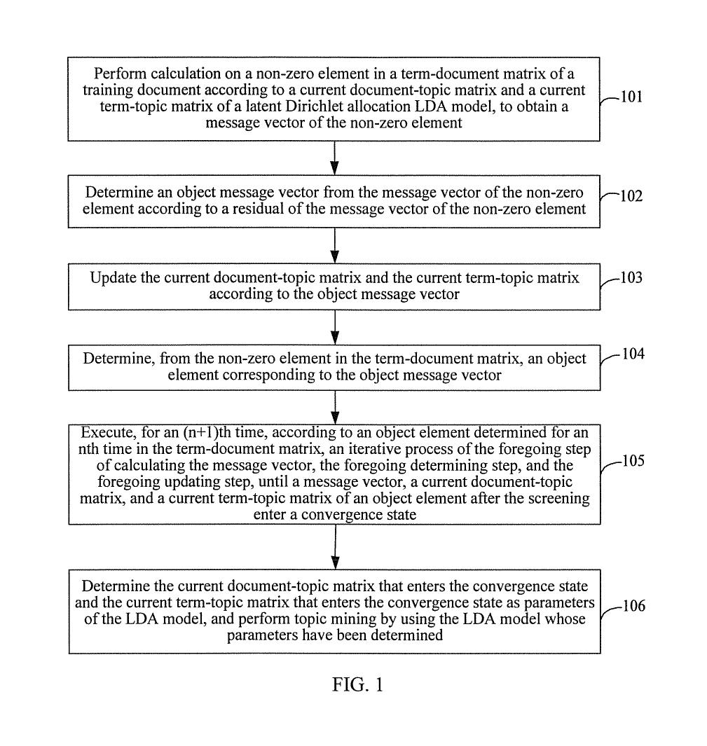

FIG. 1 is a schematic flowchart of a topic mining method according to an embodiment of the present invention. As shown in FIG. 1, this embodiment may include the following steps:

101: Perform calculation on a non-zero element in a term-document matrix of a training document according to a current document-topic matrix and a current term-topic matrix of a latent Dirichlet allocation LDA model, to obtain a message vector (for example, Mₙ) of the non-zero element.

The term-document matrix is in a form of a bag-of-words matrix or a form of a term frequency-inverse document frequency (TF-IDF) matrix. If an iterative process that includes steps 101 to 103 is executed for the first time, an object element may be all non-zero elements in the term-document matrix; otherwise, an object element is an object element determined in step 103 in the iterative process executed at a previous time.

Optionally, if the term-document matrix is in the form of a bag-of-words matrix, calculation may be directly performed on the term-document matrix to obtain a message vector of an object element in the term-document matrix; or after the term-document matrix in the form of a bag-of-words matrix is converted into the term-document matrix in the form of a TF-IDF matrix, calculation is performed on the term-document matrix in the form of a TF-IDF matrix, to obtain a message vector of an object element in the term-document matrix. The message vector indicates possibilities of topics that an element in the term-document matrix involves. For example, a message vector μ_{w,d}(k) indicates a possibility of a k^{th} topic that an element in a w^{th} row and a d^{th} column in the term-document matrix involves, and when a total quantity of topics is K, 1≦k≦K, that is, a length of the message vector μ_{w,d}(k) is K.

It should be noted that, the term-document matrix is used to indicate a quantity of times that a term appears in a document. Using a term-document matrix in the form of a bag-of-words matrix as an example, in the matrix, each row corresponds to one term, and each column corresponds to one document. A value of each non-zero element in the matrix indicates a quantity of times that a term corresponding to a row in which the element is located appears in a document corresponding to a column in which the element is located. If a value of an element is zero, it indicates that a term corresponding to a row in which the element is located does not appear in a document corresponding to a column in which the element is located. In a term-topic matrix, each row corresponds to one term, and each column corresponds to one topic. A value of an element in the matrix indicates a probability that a topic corresponding to a column in which the element is located involves a term corresponding to a row in which the element is located. In a document-topic matrix, each row corresponds to one document, and each column corresponds to one topic. A value of an element in the matrix indicates a probability that a document corresponding to a row in which the element is located involves a topic corresponding to a column in which the element is located.

102: Determine an object message vector (for example, ObjectMₙ) from the message vector of the non-zero element according to a residual of the message vector of the non-zero element.

The object message vector is a message vector that ranks in a top preset proportion in descending order of residuals. A residual (residual) is used to indicate a convergence degree of a message vector.

Optionally, a residual of a message vector is calculated; the residual obtained by means of calculation is queried for an object residual that ranks in a top preset proportion (λₖ×λ_{w}) in descending order; and a message vector corresponding to the object residual is determined as an object message vector, where the object message vector has a relatively high residual and a relatively low convergence degree. A value range of (λₖ×λ_{w}) is less than 1 and greater than 0, that 0<(λₖ×λ_{w})<1. A value of (λₖ×λ_{w}) is determined according to efficiency of topic mining and accuracy of a result of topic mining. Specifically, a smaller value of (λₖ×λ_{w}) indicates a smaller operation amount and higher efficiency of topic mining, but a relatively large error of a result of topic mining. A larger value indicates a larger operation amount and lower efficiency of topic mining, but a relatively small error of a result of topic mining.

103: Update the current document-topic matrix and the current term-topic matrix according to the object message vector.

Specifically, calculation is performed according to a message vector μ_{w,d}ⁿ(k), to obtain

$${θ}_{d}^{n} ( k ) = {\sum }_{w} {x}_{w , d} {μ}_{w , d}^{n} ( k ) ,$$

and a value of an element in a k^{th} row and a d^{th} column in the current document-topic matrix of the LDA model is updated by using θ_{d}ⁿ(k), where k=1, 2, . . . , K, K is a preset quantity of topics, x_{w,d} is a value of the element in a w^{th} row and a d^{th} column in the term-document matrix, and μ_{w,d}ⁿ(k) is a value of a k^{th} element of a message vector obtained by performing, in the iterative process executed for the n^{th} time, calculation on x_{w,d}; and calculation

$${Φ}_{w}^{n} ( k ) = {\sum }_{d} {x}_{w , d} {μ}_{w , d}^{n} ( k ) ,$$

is performed according to μ_{w,d}ⁿ(k), to obtain and a value of an element in a k^{th} row and a w^{th} column in the current term-topic matrix of the LDA model is updated by using θ_{d}ⁿ(k).

104: Determine, from the non-zero element in the term-document matrix, an object element (for example, ObjectEₙ) corresponding to the object message vector.

Optionally, a non-zero element in a term-document matrix is queried for an element corresponding to an object message vector determined at a previous time, and an element that is in the term-document matrix and that corresponds to an object message vector is determined as an object element. Therefore, when a step of performing calculation on a term-document matrix of a training document according to a current document-topic matrix and a current term-topic matrix of an LDA model, to obtain a message vector of an object element in the term-document matrix is performed at a current time, calculation is performed on only object elements in the term-document matrix that are determined at the current time, to obtain message vectors of these object elements. A quantity of object elements that are determined when this step is performed each time is less than a quantity of object elements that are determined when this step is performed at a previous time. Therefore, a calculation amount for calculation performed on the message vector of the object element in the term-document matrix continuously decreases, and a calculation amount for updating the current document-topic matrix and the current term-topic matrix according to the object message vector also continuously decreases, which increases efficiency.

105: Execute, for an (n+1)^{th} time according to an object element (for example, ObjectEₙ) determined for an n^{th} time in the term-document matrix, an iterative process of the foregoing step of calculating the message vector, the foregoing determining step, and the foregoing updating step, until a message vector, a current document-topic matrix, and a current term-topic matrix of an object element (for example, ObjectEₚ) after the screening enter a convergence state.

Specifically, an iterative process of performing calculation on the object element determined for an n^{th} time in the term-document matrix of the training document according to the current document-topic matrix and the current term-topic matrix of the LDA model, to obtain a message vector (for example, Mₙ₊₁) of the object element determined for the n^{th} time in the term-document matrix, determining, according to a residual of the message vector of the object element determined for the n^{th} time, an object message vector (for example, ObjectMₙ₊₁) from the message vector of the object element determined for the n^{th} time, updating the current document-topic matrix and the current term-topic matrix according to the object message vector determined for the (n+1)^{th} time, and determining, from the term-document matrix, an object element (for example, ObjectEₙ₊₁) corresponding to the object message vector determined for the (n+1)^{th} time is executed for an (n+1)^{th} time, until a message vector, a current document-topic matrix, and a current term-topic matrix of an object element after the screening enter a convergence state.

It should be noted that, when the message vector, the document-topic matrix, and the term-topic matrix enter a convergence state, the message vector, the document-topic matrix, and the term-topic matrix that are obtained by executing the iterative process for the (n+1)^{th} time are correspondingly similar to the message vector, the document-topic matrix, and the term-topic matrix that are obtained by executing the iterative process for the n^{th} time. That is, a difference between the message vectors that are obtained by executing the iterative process for the (n+1)^{th} time and for the n^{th} time, a difference between the document-topic matrices that are obtained by executing the iterative process for the (n+1)^{th} time and for the n^{th} time, and a difference between the term-topic matrices that are obtained by executing the iterative process for the (n+1)^{th} time and for the n^{th} time all approach zero. That is, no matter how many more times the iterative process is executed, the message vector, the document-topic matrix, and the term-topic matrix no longer change greatly, and reach stability.

106: Determine the current document-topic matrix that enters the convergence state and the current term-topic matrix that enters the convergence state as parameters of the LDA model, and perform topic mining by using the LDA model whose parameters have been determined.

In this embodiment, when an iterative process is executed each time, an object message vector is determined from a message vector according to a residual of the message vector, and then a current document-topic matrix and a current term-topic matrix are updated according to only an object message vector that is determined by executing the iterative process at a current time, so that when the iterative process is executed subsequently, calculation is performed, according to the current document-topic matrix and the current term-topic matrix that are updated by executing the iterative process at a previous time, on an object element that is in the term-document matrix and that corresponds to the object message vector determined by executing the iterative process at a previous time, thereby avoiding that in each iterative process, calculation needs to be performed on all non-zero elements in the term-document matrix, and avoiding that the current document-topic matrix and the current term-topic matrix are updated according to all message vectors, which greatly reduces an operation amount, increases a speed of topic mining, and increases efficiency of topic mining.

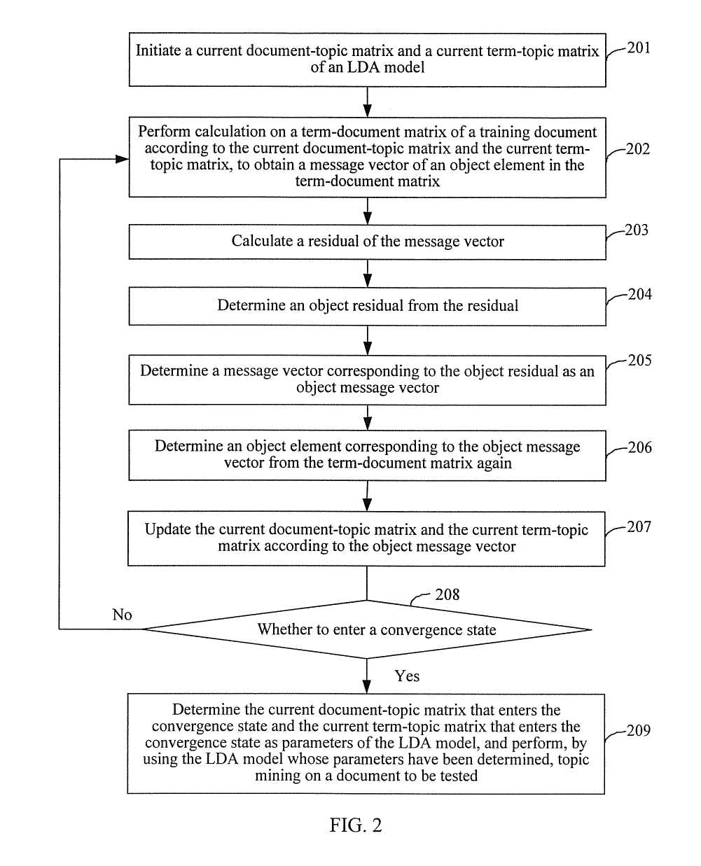

FIG. 2 is a schematic flowchart of a topic mining method according to another embodiment of the present invention. A document-topic matrix in this embodiment is in a form of a bag-of-words matrix. As shown in FIG. 2, this embodiment includes the following steps: 201: Initiate a current document-topic matrix θ_{d}⁰(k) and a current term-topic matrix Φ_{w}⁰(k) of an LDA model.

Optionally, on the basis of

$${\sum }_{k} {μ}_{w , d}^{0} ( k ) = 1$$

and μ_{w,d}⁰(k)≧0, a message vector of each non-zero element in a term-document matrix of a training document is determined, where the message vector includes K elements, each element in the message vector corresponds to one topic, the message vector indicates probabilities that a term in a document indicated by the term-document matrix involves topics. For example, an initial message vector μ_{w,d}⁰(k) indicates a probability that an element x_{w,d} in a w^{th} row and a d^{th} column in the term-document matrix involves a k^{th} topic, and calculation is performed according to the initial message vector μ_{w,d}⁰(k), to obtain a current document-topic matrix

$${θ}_{d}^{0} ( k ) = {\sum }_{w} {x}_{w , d} {μ}_{w , d}^{0} ( k ) .$$

Calculation is performed according to the initial message vector μ_{w,d}⁰(k), to obtain a current term-topic matrix

$${Φ}_{w}^{0} ( k ) = {\sum }_{d} {x}_{w , d} {μ}_{w , d}^{0} ( k ) ,$$

where k=1, 2, . . . , K, w=1, 2, . . . , W, and d=1, 2, . . . , D. W is a length of a term list, that is, a quantity of terms that are included in a term list, and is equal to a quantity of rows that are included in the term-document matrix; D is a quantity of training documents; K is a preset quantity of topics, where the quantity of topics may be set by a user before the user performs topic mining, and a larger quantity of topics indicates a larger calculation amount. Value ranges of W, D, and K are all positive integers.

Further, before 201, statistics are collected on whether each training document includes a term in a standard dictionary, and a quantity of times that the term appears, and a term-document matrix in a form of a bag-of-words matrix is generated by using a statistical result. Each row in the term-document matrix in the form of a bag-of-words matrix corresponds to one term, and each column corresponds to one document; a value of each non-zero element in the matrix indicates a quantity of times that a term corresponding to a row in which the element is located appears in a document corresponding to a column in which the element is located. If a value of an element is zero, it indicates that a term corresponding to a row in which the element is located does not appear in a document corresponding to a column in which the element is located.

202: Perform calculation on a term-document matrix of a training document according to the current document-topic matrix and the current term-topic matrix, to obtain a message vector of an object element in the term-document matrix.

If 202 is performed for the first time, it is determined that an iterative process is executed for the first time, and the object element is all non-zero elements in the term-document matrix; otherwise, the object element is an object element that is determined in the iterative process executed at a previous time.

Optionally, calculation is performed by substituting the current document-topic matrix θ_{d}⁰(k), the current term-topic matrix Φ_{w}⁰(k), and n=1 into a formula

$${μ}_{w , d}^{n} ( k ) ∝ \frac{[ {θ}_{d}^{n - 1} ( k ) + α ] \times [ {Φ}_{w}^{n - 1} ( k ) + β ]}{{\sum }_{w} {Φ}_{w}^{n - 1} ( k ) + W β} ,$$

to obtain a message vector

$${μ}_{w , d}^{1} ( k ) ∝ \frac{[ {θ}_{d}^{0} ( k ) + α ] \times [ {Φ}_{w}^{0} ( k ) + β ]}{{\sum }_{w} {Φ}_{w}^{0} ( k ) + W β}$$

of each non-zero element in the term-document matrix, where n is a quantity of times that the iterative process is executed, where for example, if the iterative process is executed for the first time, n=1; μ_{w,d}¹(k) is a message vector on a k^{th} topic, in the iterative process executed for the first time, for an element x_{w,d} in a w^{th} row and a d^{th} column in the term-document matrix; μ_{w,d}ⁿ(k) is a message vector that is obtained by performing, in the iterative process executed for an n^{th} time, on the k^{th} topic, calculation on an element in the w^{th} row and the d^{th} column in the term-document matrix; and α and β are preset coefficients. Generally, the two preset coefficients are referred to as super parameters of the LDA model, and value ranges of the two preset coefficients are non-negative numbers, for example, {α=0.016, β=0.01}.

It should be noted that, when 202 is performed for the first time, the iterative process begins, and it is recorded as that the iterative process is executed for the first time and n=1.

203: Calculate a residual of a message vector.

Optionally, a residual r_{w,d}¹(k)=x_{w,d}|μ_{w,d}¹(k)−μ_{w,d}⁰(k)| of a message vector μ_{w,d}¹(k) is obtained by means of calculation according to a formula r_{w,d}ⁿ(k)=x_{w,d}|μ_{w,d}ⁿ(k)−μ_{w,d}ⁿ⁻¹(k)| by substituting n=1 and μ_{w,d}¹(k), where x_{w,d} is a value of the element in a w^{th} row and a d^{th} column in the term-document matrix, μ_{w,d}ⁿ⁻¹(k) is a message vector that is obtained by performing, in the iterative process executed for an (n−1)^{th} time, on a k^{th} topic, calculation on an element in the w^{th} row and the d^{th} column in the term-document matrix.

204: Determine an object residual from the residual.

Optionally, calculation is performed by substituting the residual r_{w,d}¹(k) and n=1 into a formula

$${r}_{w}^{n} ( k ) = {\sum }_{d} {r}_{w , d}^{n} ( k ) ,$$

to obtain a cumulative residual matrix

$${r}_{w}^{1} ( k ) = {\sum }_{d} {r}_{w , d}^{1} ( k ) ,$$

where r_{w}¹(k) is a value of an element, in the iterative process executed for the first time, in a w^{th} row and a k^{th} column in the cumulative residual matrix. In each row in the cumulative residual matrix, a column ρ_{w}¹(k) in which an element that ranks in a top preset proportion λₖ in descending order is determined by using a fast sorting algorithm and an insertion sorting algorithm, and the element determined in each row is accumulated, to obtain a sum value corresponding to each row. A row ρ_{w}¹ corresponding to a sum value that ranks in a top preset proportion λ_{w} in descending order is determined by using the fast sorting algorithm and the insertion sorting algorithm, and r_{ρ}_{_{w}}_{¹}_{,d}¹(ρ_{w}¹(k)) is determined as the object residual. The foregoing λₖ and λ_{w} need to be preset before the topic mining is performed, where 0<λₖ≦1, 0<λ_{w}≦1, and λₖ×λ_{w}≠1.

Alternatively, optionally, calculation is performed according to a residual r_{d}ⁿ(k), to obtain a cumulative residual matrix

$${r}_{d}^{n} ( k ) = {\sum }_{w} {r}_{w , d}^{n} ( k ) ,$$

where r_{d}ⁿ(k) is a value of an element, in the iterative process executed for the n^{th} time, in a d^{th} row and a k^{th} column in the cumulative residual matrix. In each row of the cumulative residual matrix, a column ρ_{d}ⁿ(k) in which an object element that ranks in a top preset proportion λₖ in descending order is determined by using a fast sorting algorithm and an insertion sorting algorithm, and the object element determined in each row is accumulated, to obtain a sum value corresponding to each row. A row ρ_{d}ⁿ corresponding to a sum value that ranks in a top preset proportion λ_{w} in descending order is determined by using the fast sorting algorithm and the insertion sorting algorithm, and a residual r_{w,ρ}_{_{d}}_{ⁿ}ⁿ(ρ_{d}ⁿ(k)) that meets k=ρ_{w}ⁿ(k), d=ρ_{w}ⁿ is determined as the object residual. The foregoing λₖ and λ_{w} need to be preset before the topic mining is performed, where 0<λₖ≦1, 0<λ_{w}≦1, and λₖ×λ_{w}≠1.

205: Determine a message vector corresponding to the object residual as an object message vector.

Optionally, n=1 is substituted according to a correspondence between an object residual r_{ρ}_{_{w}}_{ⁿ}_{,d}ⁿ(ρ_{w}ⁿ(k)) and a message vector μ_{ρ}_{_{w}}_{ⁿ}_{,d}ⁿ(ρ_{w}ⁿ(k)), to determine a message vector μ_{ρ}_{_{w}}_{¹}_{,d}¹(ρ_{w}¹(k)) corresponding to an object residual r_{ρ}_{_{w}}_{¹}_{,d}¹(ρ_{w}ⁿ(k)), and then the message vector μ_{ρ}_{_{w}}_{¹}_{,d}¹(ρ_{w}¹(k)) is the object message vector.

206: Determine an object element corresponding to the object message vector from the term-document matrix again.

Optionally, an object element x_{ρ}_{_{w}}_{¹}_{,d} in the term-document matrix corresponding to the object message vector μ_{ρ}_{_{w}}_{¹}_{,d}¹(ρ_{w}¹(k)) is determined from the object element in 201 according to a correspondence between an object message vector μ′_{w,d}ⁿ(k) and an element x_{w,d} in the term-document matrix.

207: Update the current document-topic matrix and the current term-topic matrix according to the object message vector.

Optionally, calculation is performed by substituting the object message vector μ_{ρ}_{_{w}}_{¹}_{,d}¹(ρ_{w}¹(k)) into a formula

$${θ}_{w}^{n} ( k ) = {\sum }_{w} {x}_{w , d} {μ}_{w , d}^{n} ( k ) ,$$

to obtain θ_{d}¹(k), k=ρ_{w}¹(k), and the current document-topic matrix is updated by using θ_{d}¹(k). Calculation is performed by substituting the object message vector μ_{ρ}_{_{w}}_{¹}_{,d}¹(ρ_{w}¹(k)) into a formula

$${Φ}_{w}^{n} ( k ) = {\sum }_{d} {x}_{w , d} {μ}_{w , d}^{n} ( k ) ,$$

to obtain Φ_{w}¹(k), k=ρ_{w}¹(k), and the current term-topic matrix is updated by using Φ_{w}¹(k).

It should be noted that, 202 to 207 are one complete iterative process, and after 207 is performed, the iterative process is completed.

208: Determine whether a message vector, a current document-topic matrix, and a current term-topic matrix of an object element after the screening enter a convergence state, and if the message vector, the current document-topic matrix, and the current term-topic matrix of the object element after the screening enter a convergence state, perform step 209; if the message vector, the current document-topic matrix, and the current term-topic matrix of the object element after the screening do not enter a convergence state, perform step 202 to step 207 again.

Optionally, calculation is performed by substituting into a formula

$${r}^{n} ( k ) = {\sum }_{w} {r}_{w}^{n} ( k ) ,$$

and whether rⁿ(k) divided by W approaches zero is determined. If rⁿ(k) divided by W approaches zero, it is determined that the message vector, the current document-topic matrix, and the current term-topic matrix of the object element after the screening have converged to a stable state; if rⁿ(k) divided by W does not approach zero, it is determined that the message vector, the current document-topic matrix, and the current term-topic matrix do not enter a convergence state.

209: Determine the current document-topic matrix that enters the convergence state and the current term-topic matrix that enters the convergence state as parameters of the LDA model, and perform, by using the LDA model whose parameters have been determined, topic mining on a document to be tested.

In this embodiment, when an iterative process is executed each time, an object message vector is determined from a message vector according to a residual of the message vector, and then a current document-topic matrix and a current term-topic matrix are updated according to only an object message vector that is determined by executing the iterative process at a current time, so that when the iterative process is executed subsequently, calculation is performed, according to the current document-topic matrix and the current term-topic matrix that are updated by executing the iterative process at a previous time, on an object element that is in the term-document matrix and that corresponds to the object message vector determined by executing the iterative process at a previous time, thereby avoiding that in each iterative process, calculation needs to be performed on all non-zero elements in the term-document matrix, and avoiding that the current document-topic matrix and the current term-topic matrix are updated according to all message vectors, which greatly reduces an operation amount, increases a speed of topic mining, and increases efficiency of topic mining. In addition, in this embodiment, when a residual is queried, in descending order, for an object residual that ranks in a top preset proportion, a solution is specifically used. In the solution, in each row in a cumulative residual matrix obtained by means of calculation according to the residual, a column in which an element that ranks in a top preset proportion in descending order is determined by using a fast sorting algorithm and an insertion sorting algorithm, and then the element deter mined in each row is accumulated, to obtain a sum value corresponding to each row, a row corresponding to a sum value that ranks in a top preset proportion in descending order is determined by using the fast sorting algorithm and the insertion sorting algorithm, and an element located in the determined row and column is determined as the object residual, so that a query speed of the object residual is increased, and efficiency of topic mining is further increased.

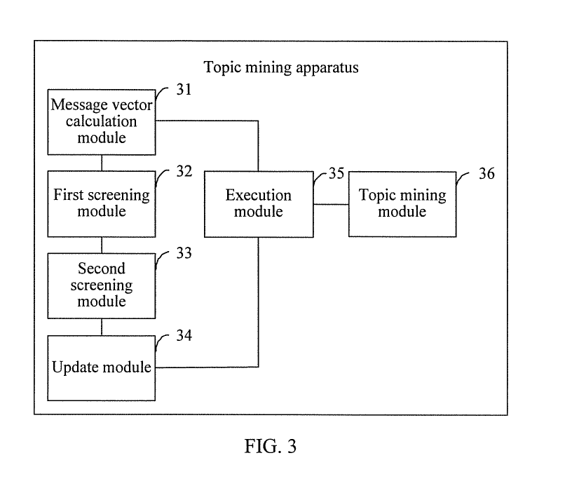

FIG. 3 is a schematic structural diagram of a topic mining apparatus according to an embodiment of the present invention. As shown in FIG. 3, the apparatus includes: a message vector calculation module 31, a first screening module 32, a second screening module 33, an update module 34, an execution module 35, and a topic mining module 36.

The message vector calculation module 31 is configured to perform calculation on a non-zero element in a term-document matrix of a training document according to a current document-topic matrix and a current term-topic matrix of a latent Dirichlet allocation LDA model, to obtain a message vector of the non-zero element.

The first screening module 32 is connected to the message vector calculation module 31, and is configured to determine an object message vector from the message vector of the non-zero element according to a residual of the message vector of the non-zero element.

The object message vector is a message vector that ranks in a top preset proportion in descending order of residuals, a value range of the preset proportion is less than 1 and greater than 0, and a residual is used to indicate a convergence degree of a message vector.

The second screening module 33 is connected to the first screening module 32, and is configured to determine, from the non-zero element in the term-document matrix, an object element corresponding to the object message vector.

The update module 34 is connected to the first screening module 33, and is configured to update the current document-topic matrix and the current term-topic matrix of the LDA model according to the object message vector.

The execution module 35 is connected to the message vector calculation module 31 and the update module 34, and is configured to execute, for an (n+1)^{th} time, an iterative process of performing calculation on the object element determined for an n^{th} time in the term-document matrix of the training document according to the current document-topic matrix and the current term-topic matrix of the LDA model, to obtain a message vector of the object element determined for the n^{th} time in the term-document matrix, determining, according to a residual of the message vector of the object element determined for the n^{th} time, an object message vector from the message vector of the object element determined for the n^{th} time, updating the current document-topic matrix and the current term-topic matrix according to the object message vector determined for the (n+1)^{th} time, and determining, from the term-document matrix, an object element corresponding to the object message vector determined for the (n+1)^{th} time, until a message vector, a current document-topic matrix, and a current term-topic matrix of an object element after the screening enter a convergence state.

The topic mining module 36 is connected to the execution module 35, and is configured to determine the current document-topic matrix that enters the convergence state and the current term-topic matrix that enters the convergence state as parameters of the LDA model, and perform, by using the LDA model whose parameters have been determined, topic mining on a document to be tested.

In this embodiment, when an iterative process is executed each time, an object message vector is determined from a message vector according to a residual of the message vector, and then a current document-topic matrix and a current term-topic matrix are updated according to only an object message vector that is determined by executing the iterative process at a current time, so that when the iterative process is executed subsequently, calculation is performed, according to the current document-topic matrix and the current term-topic matrix that are updated by executing the iterative process at a previous time, on an object element that is in the term-document matrix and that corresponds to the object message vector determined by executing the iterative process at a previous time, thereby avoiding that in each iterative process, calculation needs to be performed on all non-zero elements in the term-document matrix, and avoiding that the current document-topic matrix and the current term-topic matrix are updated according to all message vectors, which greatly reduces an operation amount, increases a speed of topic mining, and increases efficiency of topic mining.

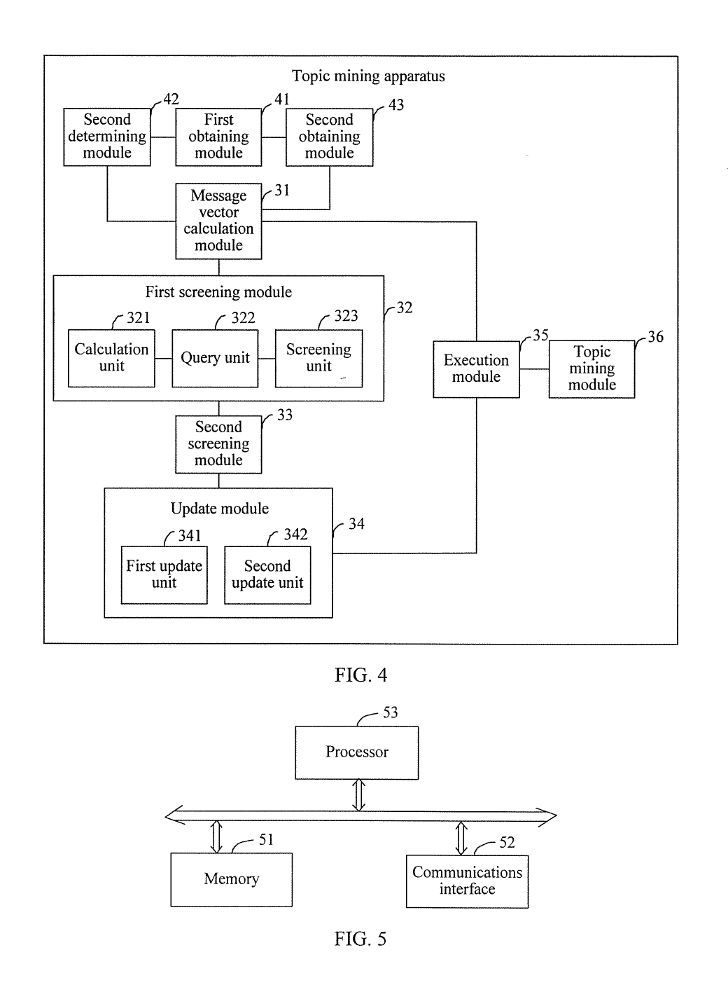

FIG. 4 is a schematic structural diagram of a topic mining apparatus according to another embodiment of the present invention. As shown in FIG. 4, on the basis of the foregoing embodiment, the first screening module 32 in this embodiment further includes: a calculation unit 321, a query unit 322, and a screening unit 323.

The calculation unit 321 is configured to calculate the residual of the message vector of the non-zero element.

Optionally, the calculation unit 321 is specifically configured to obtain by means of calculation a residual r_{w,d}ⁿ(k)=x_{w,d}|μ_{w,d}ⁿ(k)−μ_{w,d}ⁿ⁻¹(k)| of a message vector μ_{w,d}ⁿ(k), where k=1, 2, . . . , K, K is a preset quantity of topics, μ_{w,d}ⁿ(k) is a value of a k^{th} element of a message vector obtained by performing, in the iterative process executed for the n^{th} time, calculation on an element in a w^{th} row and a d^{th} column in the term-document matrix, x_{w,d} is a value of the element in the w^{th} row and the d^{th} column in the term-document matrix, and μ_{w,d}ⁿ⁻¹(k) is a value of a k^{th} element of a message vector obtained by performing, in the iterative process executed for an (n−1)^{th} time, calculation on the element in the w^{th} row and the d^{th} column in the term-document matrix.

The query unit 322 is connected to the calculation unit 321, and is configured to query, in descending order, the residual obtained by means of calculation for an object residual that ranks in the top preset proportion (λₖ×λ_{w}).

A value range of (λₖ×λ_{w}) is less than 1 and greater than 0. The preset proportion is determined according to efficiency of topic mining and accuracy of a result of the topic mining.

Optionally, the query unit 322 is specifically configured to perform calculation according to the residual r_{w,d}ⁿ(k), to obtain a cumulative residual matrix

$${r}_{w}^{n} ( k ) = {\sum }_{d} {r}_{w , d}^{n} ( k ) ,$$

where r_{w,d}ⁿ(k) is a value of a k^{th} element, in the iterative process executed for the n^{th} time, of a residual of the message vector of the element in the w^{th} row and the d^{th} column in the term-document matrix; r_{w}ⁿ(k) is a value of an element, in the iterative process executed for the n^{th} time, in a w^{th} row and a k^{th} column in the cumulative residual matrix; in each row in the cumulative residual matrix, determine a column ρ_{w,n}(k) in which an object element that ranks a top preset proportion λₖ in descending order, where a value range of λ_{w} is less than 1 and greater than 0; accumulate the object element determined in each row, to obtain a sum value corresponding to each row; determine a row ρ_{w}ⁿ corresponding to a sum value that ranks in the top preset proportion λ_{w} in descending order, where a value range of λ_{w} is less than 1 and greater than 0; and determine a residual r_{ρ}_{_{w}}_{ⁿ}_{,d}ⁿ(ρ_{w}ⁿ(k)) that meets k=ρ_{w}ⁿ(k), w=ρ_{w}ⁿ as the object residual.

The screening unit 323 is connected to the query unit 322, and is configured to determine, from the message vector of the non-zero element, the object message vector corresponding to the object residual.

Optionally, the screening unit 323 is specifically configured to determine, from the message vector of the non-zero element, a message vector μ_{ρ}_{_{w}}_{ⁿ}_{,d}ⁿ(ρ_{w}ⁿ(k)) corresponding to the object residual r_{ρ}_{_{w}}_{ⁿ}_{,d}ⁿ(ρ_{w}ⁿ(k)).

Further, the update module 34 includes: a first update unit 341 and a second update unit 342.

The first update unit 341 is configured to perform calculation on the object message vector μ_{w,d}ⁿ(k) according to a formula

$${θ}_{d}^{n} ( k ) = {\sum }_{w} {x}_{w , d} {μ}_{w , d}^{n} ( k ) ,$$

to obtain a value of an element θ_{d}ⁿ(k) in a k^{th} row and a d^{th} column in an updated current document-topic matrix of the LDA model, and update a value of an element in a k^{th} row and a d^{th} column in the current document-topic matrix of the LDA model by using θ_{d}ⁿ(k), where k=1, 2, . . . , K, K is a preset quantity of topics, x_{w,d} is a value of the element in a w^{th} row and the d^{th} column in the term-document matrix, and μ_{w,d}ⁿ(k) is a value of the k^{th} element of the message vector obtained by performing, in the iterative process executed for the n^{th} time, calculation on x_{w,d}.

The second update unit 342 is configured to obtain by means of calculation, according to a formula

$${Φ}_{w}^{n} ( k ) = {\sum }_{d} {x}_{w , d} {μ}_{w , d}^{n} ( k ) {μ}_{w , d}^{n} ( k ) ,$$

a value Φ_{w}ⁿ(k) of an element in a k^{th} row and a w^{th} column in an updated current term-topic matrix of the LDA model, and update a value of an element in a k^{th} row and a w^{th} column in the current term-topic matrix of the LDA model by using Φ_{w}ⁿ(k).

Further, the topic mining apparatus further includes: a determining module 41, a first obtaining module 42, and a second obtaining module 43.

The second determining module 41 is configured to determine an initial message vector μ_{w,d}ⁿ(k) of each non-zero element in the term-document matrix, where k=1, 2, . . . , K, K is a preset quantity of topics,

$${\sum }_{d} {μ}_{w , d}^{0} ( k ) = 1 ,$$

and μ_{w,d}⁰(k)≧0, where μ_{w,d}⁰(k) is a k^{th} element of the initial message vector of the non-zero element x_{w,d} in the w^{th} row and the d^{th} column in the term-document matrix.

The first obtaining module 42 is connected to the second determining module 41 and the message vector calculation module 31, and is configured to calculate the current document-topic matrix according to a formula

$${θ}_{d}^{0} ( k ) = {\sum }_{w} {x}_{w , d} {μ}_{w , d}^{0} ( k ) ,$$

where μ_{w,d}⁰(k) is the initial message vector, and θ_{w,d}ⁿ(k) is a value of an element in a k^{th} row and a d^{th} column in the current document-topic matrix.

The second obtaining module 43 is connected to the second determining module 41 and the message vector calculation module 31, and is configured to calculate the current term-topic matrix according to a formula

$${Φ}_{w}^{0} ( k ) = {\sum }_{d} {x}_{w , d} {μ}_{w , d}^{0} ( k ) ,$$

where μ_{w,d}⁰(k) is the initial message vector, and Φ_{w}⁰(k) is a value of an element in a k^{th} row and a w^{th} column in the current term-topic matrix.

Further, the message vector calculation module 31 is specifically configured to: in the iterative process executed for the n^{th} time, perform calculation according to a formula

$${μ}_{w , d}^{n} ( k ) ∝ \frac{[ {θ}_{d}^{n - 1} ( k ) + α ] \times [ {Φ}_{w}^{n - 1} ( k ) + β ]}{{\sum }_{w} {Φ}_{w}^{n - 1} ( k ) + W β} ,$$

to obtain a value μ_{w,d}ⁿ(k) of a k^{th} element of the message vector of the element x_{w,d} in the w^{th} row and the d^{th} column in the term-document matrix, where k=1, 2, . . . , K, K is a preset quantity of topics, w=1, 2, . . . , W, W is a length of a term list, d=1, 2, . . . , D, D is a quantity of the training documents, θ_{d}ⁿ(k) is a value of an element in a k^{th} row and a d^{th} column in the current document-topic matrix, Φ_{w}ⁿ(k) is a value of an element in a k^{th} row and a w^{th} column in the current term-topic matrix, and α and β are preset coefficients whose value ranges are positive numbers.

Functional modules of the topic mining apparatus that is provided in this embodiment may be configured to execute a procedure of the topic mining method shown in FIG. 1 and FIG. 2. Details about an operating principle of the procedure are not described again. For details, refer to descriptions in the method embodiments.

In this embodiment, when an iterative process is executed each time, an object message vector is determined from a message vector according to a residual of the message vector, and then a current document-topic matrix and a current term-topic matrix are updated according to only an object message vector that is determined by executing the iterative process at a current time, so that when the iterative process is executed subsequently, calculation is performed, according to the current document-topic matrix and the current term-topic matrix that are updated by executing the iterative process at a previous time, on an object element that is in the term-document matrix and that corresponds to the object message vector determined by executing the iterative process at a previous time, thereby avoiding that in each iterative process, calculation needs to be performed on all non-zero elements in the term-document matrix, and avoiding that the current document-topic matrix and the current term-topic matrix are updated according to all message vectors, which greatly reduces an operation amount, increases a speed of topic mining, and increases efficiency of topic mining. In addition, in this embodiment, when a residual is queried, in descending order, for an object residual that ranks in a top preset proportion, a solution is specifically used. In the solution, in each row in a cumulative residual matrix obtained by means of calculation according to the residual, a column in which an element that ranks in a top preset proportion in descending order is determined by using a fast sorting algorithm and an insertion sorting algorithm, and then the element determined in each row is accumulated, to obtain a sum value corresponding to each row, a row corresponding to a sum value that ranks in a top preset proportion in descending order is determined by using the fast sorting algorithm and the insertion sorting algorithm, and an element located in the determined row and column is determined as the object residual, so that a query speed of the object residual is increased, and efficiency of topic mining is further increased.

FIG. 5 is a schematic structural diagram of a topic mining apparatus according to still another embodiment of the present invention. As shown in FIG. 5, the apparatus in this embodiment may include: a memory 51, a communications interface 52, and a processor 53.

The memory 51 is configured to store a program. Specifically, the program may include program code, and the program code includes a computer operation instruction. The memory 51 may include a high-speed RAM memory, and may further include a non-volatile memory (non-volatile memory), such as at least one magnetic disk memory.

The communications interface 52 is configured to obtain a term-document matrix of a training document.

The processor 53 is configured to execute the program stored in the memory 51, to perform calculation on a non-zero element in a term-document matrix of a training document according to a current document-topic matrix and a current term-topic matrix of a latent Dirichlet allocation LDA model, to obtain a message vector of the non-zero element; determine an object message vector from the message vector of the non-zero element according to a residual of the message vector of the non-zero element, where the object message vector is a message vector that ranks in a top preset proportion in descending order of residuals, and a value range of the preset proportion is less than 1 and greater than 0; update the current document-topic matrix and the current term-topic matrix of the LDA model according to the object message vector; determine, from the non-zero element in the term-document matrix, an object element corresponding to the object message vector; repeatedly execute an iterative process of performing calculation on the object element determined at a previous time in the term-document matrix of the training document according to the current document-topic matrix and the current term-topic matrix of the LDA model, to obtain a message vector of the object element determined at a previous time in the term-document matrix, determining, according to a residual of the message vector of the object element determined at a previous time, an object message vector from the message vector of the object element determined at a previous time, updating the current document-topic matrix and the current term-topic matrix according to the object message vector determined at a current time, and determining, from the term-document matrix, an object element corresponding to the object message vector determined at a current time, until a message vector, a current document-topic matrix, and a current term-topic matrix of an object element after the screening enter a convergence state; and determine the current document-topic matrix that enters the convergence state and the current term-topic matrix that enters the convergence state as parameters of the LDA model, and perform, by using the LDA model whose parameters have been determined, topic mining on a document to be tested.

Functional modules of the topic mining apparatus that is provided in this embodiment may be configured to execute a procedure of the topic mining method shown in FIG. 1 and FIG. 2. Details about an operating principle of the procedure are not described again. For details, refer to descriptions in the method embodiments.

An embodiment of the present invention further provides an application scenario of a topic mining apparatus:

When information processing, for example, online public opinion analysis or personalized information pushing, which needs to be performed based on semantics is performed, topic mining needs to be performed on documents to be tested on a network at first, to obtain topics of the documents to be tested, that is, themes expressed by authors by means of the documents. Subsequently, analysis may be performed based on the topics of the documents to be tested, and a result of the analysis may be used in an aspect such as the personalized information pushing or online public opinion warning.

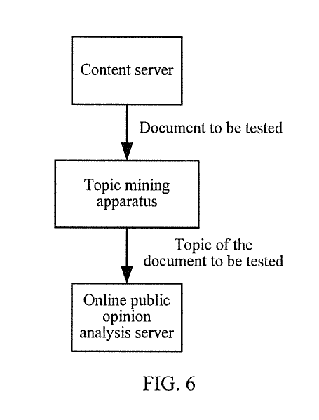

As a possible application scenario of topic mining, before online public opinion analysis is performed, topic mining needs to be performed on documents to be tested that include microblog posts and webpage text content that are on a network, so as to obtain topics of the documents to be tested. Specifically, FIG. 6 is an architecture diagram in which a topic mining apparatus is applied to online public opinion analysis. A document to be tested may be acquired from a content server, and then a document involving different topics is selected from the documents to be tested, or a document, involving different topics, other than the documents to be tested is additionally selected, and is used as a training document. When the training document covers more topics, accuracy of topic mining is higher. Next, the training document is processed by using the topic mining method provided in the foregoing embodiments, to determine a parameter of an LDA model. After the parameter of the LDA model is determined, topic mining may be performed, by using the LDA model whose parameter has been determined, on the documents to be tested that include microblog posts and webpage text content that are on a network. Obtained topics of the documents to be tested are sent to an online public opinion analysis server, to perform online public opinion analysis.

In this embodiment, when an iterative process is executed each time, an object message vector is determined from a message vector according to a residual of the message vector, and then a current document-topic matrix and a current term-topic matrix are updated according to only an object message vector that is determined by executing the iterative process at a current time, so that when the iterative process is executed subsequently, calculation is performed, according to the current document-topic matrix and the current term-topic matrix that are updated by executing the iterative process at a previous time, on an object element that is in the term-document matrix and that corresponds to the object message vector determined by executing the iterative process at a previous time, thereby avoiding that in each iterative process, calculation needs to be performed on all non-zero elements in the term-document matrix, and avoiding that the current document-topic matrix and the current term-topic matrix are updated according to all message vectors, which greatly reduces an operation amount, increases a speed of topic mining, and increases efficiency of topic mining.

Persons of ordinary skill in the art may understand that all or some of the steps of the method embodiments may be implemented by a program instructing relevant hardware. The program may be stored in a computer-readable storage medium. When the program runs, the steps of the method embodiments are performed. The foregoing storage medium includes: any medium that can store program code, such as a ROM, a RAM, a magnetic disk, or an optical disc.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

What is claimed is:

1. A topic mining method, the method comprising:
performing calculation on a non-zero element in a term-document matrix of a training document according to a current document-topic matrix and a current term-topic matrix of a latent Dirichlet allocation (LDA) model, to obtain a message vector Mₙ of the non-zero element;
determining an object message vector ObjectMₙ from the message vector Mₙ of the non-zero element according to a residual of the message vector of the non-zero element, wherein the object message vector is a message vector that ranks in a top preset proportion in descending order of residuals, and a value range of the preset proportion is less than 1 and greater than 0;
updating the current document-topic matrix and the current term-topic matrix of the LDA model according to the object message vector ObjectMₙ;
determining, from the non-zero element in the term-document matrix, an object element ObjectEₙ corresponding to the object message vector ObjectMₙ;
executing, for an (n+1)^{th} time, an iterative process of performing calculation on the object element ObjectEₙ determined for an n^{th} time in the term-document matrix of the training document according to the current document-topic matrix and the current term-topic matrix of the LDA model, to obtain a message vector Mₙ₊₁ of the object element ObjectEₙ determined for the n^{th} time in the term-document matrix;
determining, according to a residual of the message vector of the object element determined for the n^{th} time, an object message vector ObjectMₙ₊₁ from the message vector Mₙ₊₁ of the object element ObjectEₙ determined for the n^{th} time;
updating the current document-topic matrix and the current term-topic matrix according to the object message vector ObjectMₙ₊₁ determined for the (n+1)^{th} time, and determining, from the term-document matrix, an object element ObjectEₙ₊₁ corresponding to the object message vector ObjectMₙ₊₁ determined for the (n+1)^{th} time, until a message vector, a current document-topic matrix, and a current term-topic matrix of an object element ObjectEₚ after the screening enter a convergence state;
determining the current document-topic matrix that enters the convergence state and the current term-topic matrix that enters the convergence state as parameters of the LDA model; and
performing, by using the LDA model whose parameters have been determined, topic mining on a document to be tested.

2. The topic mining method according to claim 1, wherein determining the object message vector ObjectMₙ from the message vector Mₙ of the non-zero element according to the residual of the message vector of the non-zero element comprises:
calculating the residual of the message vector of the non-zero element;
querying, in descending order, the residual obtained by means of calculation for an object residual that ranks in the top preset proportion, wherein the preset proportion is determined according to efficiency of topic mining and accuracy of a result of the topic mining; and
determining the object message vector ObjectMₙ corresponding to the object residual from the message vector Mₙ of the non-zero element.

3. The topic mining method according to claim 2, wherein calculating the residual of the message vector of the non-zero element comprises:
calculating the residual of the message vector of the non-zero element according to a formula r_{w,d}ⁿ(k)=x_{w,d}|μ_{w,d}ⁿ(k)−μ_{w,d}ⁿ⁻¹(k)|, wherein r_{w,d}ⁿ(k) is the residual of the message vector of the non-zero element, k=1, 2, . . . , K, K is a preset quantity of topics, μ_{w,d}ⁿ(k) is a value of a k^{th} element of a message vector obtained by performing, in the iterative process executed for the n^{th} time, calculation on an element in a w^{th} row and a d^{th} column in the term-document matrix, x_{w,d} is a value of the element in the w^{th} row and the d^{th} column in the term-document matrix, and μ_{w,d}ⁿ⁻¹(k) is a value of a k^{th} element of a message vector obtained by performing, in the iterative process executed for an (n−1)^{th} time, calculation on the element in the w^{th} row and the d^{th} column in the term-document matrix.

4. The topic mining method according to claim 2, wherein querying, in descending order, the residual obtained by means of calculation for an object residual that ranks in the top preset proportion comprises:
performing calculation on the residual r_{w,d}ⁿ(k) according to a formula
$${r}_{w}^{n} ( k ) = {\sum }_{d} {r}_{w , d}^{n} ( k ) ,$$
to obtain a cumulative residual matrix, wherein r_{w,d}ⁿ(k) is a value of a k^{th} element, in the iterative process executed for the n^{th} time, of a residual of the message vector of the element in the w^{th} row and the d^{th} column in the term-document matrix, and r_{w}ⁿ(k) is a value of an element, in the iterative process executed for the n^{th} time, in a w^{th} row and a k^{th} column in the cumulative residual matrix;
in each row in the cumulative residual matrix, determining, in descending order, a column ρ_{w}ⁿ(k) in which an element that ranks in the top preset proportion λₖ is located, wherein 0<λₖ≦1;
accumulating the element determined in each row, to obtain a sum value corresponding to each row;
determining a row ρ_{w}ⁿ corresponding to a sum value that ranks in the top preset proportion λ_{w} in descending order, wherein 0<λ_{w}≦1, and λₖ×λ_{w}≠1; and
determining a residual r_{ρ}_{_{w}}_{ⁿ}_{,d}ⁿ(ρ_{w}ⁿ(k)) that meets k=ρ_{w}ⁿ(k), w=ρ_{w}ⁿ as the object residual.

5. The topic mining method according to claim 4, wherein determining the object message vector ObjectMₙ corresponding to the object residual from the message vector Mₙ of the non-zero element comprises:
determining, from the message vector Mₙ of the non-zero element, the object message vector ObjectMₙ corresponding to the object residual r_{ρ}_{_{w}}_{ⁿ}_{,d}ⁿ(ρ_{w}ⁿ(k)) as μₚ_{_{w}}_{ⁿ}_{,d}ⁿ(ρ_{w}ⁿ(k)).

6. The topic mining method according to claim 3, wherein updating the current document-topic matrix and the current term-topic matrix of the LDA model according to the object message vector ObjectMₙ comprises:
performing calculation according to a formula
$${θ}_{d}^{n} ( k ) = {\sum }_{w} {x}_{w , d} {μ}_{w , d}^{n} ( k ) ,$$
to obtain a value θ_{d}ⁿ(k) of an element in a k^{th} row and a d^{th} column in an updated current document-topic matrix of the LDA model, and updating a value of an element in a k^{th} row and a d^{th} column in the current document-topic matrix of the LDA model by using θ_{d}ⁿ(k), wherein k=1, 2, . . . , K, K is a preset quantity of topics, x_{w,d} is a value of the element in the w^{th} row and the d^{th} column in the term-document matrix, and μ_{w,d}ⁿ(k) is a value of the k^{th} element of the message vector obtained by performing, in the iterative process executed for the n^{th} time, calculation on x_{w,d}; and
obtaining by means of calculation, according to a formula
$${Φ}_{w}^{n} ( k ) = {\sum }_{d} {x}_{w , d} {μ}_{w , d}^{n} ( k ) {μ}_{w , d}^{n} ( k ) ,$$
a value Φ_{w}ⁿ(k) of an element in a k^{th} row and a w^{th} column in an updated current term-topic matrix of the LDA model, and updating a value of an element in a k^{th} row and a w^{th} column in the current term-topic matrix of the LDA model by using Φ_{w}ⁿ(k).

7. The topic mining method according to claim 1, wherein performing the calculation on the non-zero element in the term-document matrix of the training document according to the current document-topic matrix and the current term-topic matrix of the latent Dirichlet allocation LDA model, to obtain the message vector Mₙ of the non-zero element comprises:
in the iterative process executed for the n^{th} time, performing calculation according to a formula
$${μ}_{w , d}^{n} ( k ) ∝ \frac{[ {θ}_{d}^{n - 1} ( k ) + α ] \times [ {Φ}_{w}^{n - 1} ( k ) + β ]}{{\sum }_{w} {Φ}_{w}^{n - 1} ( k ) + W β} ,$$
to obtain a value μ_{w,d}ⁿ(k) of a k^{th} element of the message vector of the element x_{w,d} in the w^{th} row and the d^{th} column in the term-document matrix, wherein k=1, 2, . . . , K, K is a preset quantity of topics, w=1, 2, . . . , W, W is a length of a term list, d=1, 2, . . . , D, D is a quantity of the training documents, θ_{d}ⁿ(k) is a value of an element in a k^{th} row and a d^{th} column in the current document-topic matrix, Φ_{w}ⁿ(k) is a value of an element in a k^{th} row and a w^{th} column in the current term-topic matrix, and α and β are preset coefficients whose value ranges are positive numbers.

8. The topic mining method according to claim 1, wherein before performing the calculation on the non-zero element in the term-document matrix of the training document according to the current document-topic matrix and the current term-topic matrix of the latent Dirichlet allocation LDA model, to obtain the message vector Mₙ of the non-zero element, the method further comprises:
determining an initial message vector μ_{w,d}ⁿ(k) of each non-zero element in the term-document matrix, wherein k=1, 2, . . . , K, K is a preset quantity of topics,
$${\sum }_{k} {μ}_{w , d}^{0} ( k ) = 1 ,$$
and μ_{w,d}⁰(k)≧0, wherein μ_{w,d}⁰(k) is a k^{th} element of the initial message vector of the non-zero element x_{w,d} in the w^{th} row and the d^{th} column in the term-document matrix;
calculating the current document-topic matrix according to a formula
$${θ}_{d}^{0} ( k ) = {\sum }_{w} {x}_{w , d} {μ}_{w , d}^{0} ( k ) ,$$
wherein μ_{w,d}⁰(k) is the initial message vector, and θ_{d}⁰(k) is a value of an element in a k^{th} row and a d^{th} column in the current document-topic matrix; and
calculating the current term-topic matrix according to a formula
$${Φ}_{w}^{0} ( k ) = {\sum }_{d} {x}_{w , d} {μ}_{w , d}^{0} ( k ) ,$$
wherein μ_{w,d}⁰(k) is the initial message vector, and Φ_{w}⁰(k) is a value of an element in a k^{th} row and a w^{th} column in the current term-topic matrix.

9. A topic mining apparatus, comprising:
a message vector calculation module, configured to perform calculation on a non-zero element in a term-document matrix of a training document according to a current document-topic matrix and a current term-topic matrix of a latent Dirichlet allocation LDA model, to obtain a message vector Mₙ of the non-zero element;
a first screening module, configured to determine an object message vector ObjectMₙ from the message vector Mₙ of the non-zero element according to a residual of the message vector of the non-zero element, wherein the object message vector is a message vector that ranks in a top preset proportion in descending order of residuals, and a value range of the preset proportion is less than 1 and greater than 0;
an update module, configured to update the current document-topic matrix and the current term-topic matrix of the LDA model according to the object message vector ObjectMₙ;
a second screening module, configured to determine, from the non-zero element in the term-document matrix, an object element ObjectEₙ corresponding to the object message vector ObjectMₙ;
an execution module, configured to:
execute, for an (n+1)^{th} time, an iterative process of performing calculation on the object element ObjectEₙ determined for an n^{th} time in the term-document matrix of the training document according to the current document-topic matrix and the current term-topic matrix of the LDA model, to obtain a message vector Mₙ₊₁ of the object element ObjectEₙ determined for the n^{th} time in the term-document matrix;
determine, according to a residual of the message vector of the object element determined for the n^{th} time, an object message vector ObjectMₙ₊₁ from the message vector Mₙ₊₁ of the object element ObjectEₙ determined for the n^{th} time; and
update the current document-topic matrix and the current term-topic matrix according to the object message vector ObjectMₙ₊₁ determined for the (n+1)^{th} time, and determine, from the term-document matrix, an object element ObjectEₙ₊₁ corresponding to the object message vector ObjectMₙ₊₁ determined for the (n+1)^{th} time, until a message vector, a current document-topic matrix, and a current term-topic matrix of an object element ObjectEₚ after the screening enter a convergence state; and
a topic mining module, configured to:
determine the current document-topic matrix that enters the convergence state and the current term-topic matrix that enters the convergence state as parameters of the LDA model; and
perform, by using the LDA model whose parameters have been determined, topic mining on a document to be tested.

10. The topic mining apparatus according to claim 9, wherein the first screening module comprises:
a calculation unit, configured to calculate the residual of the message vector of the non-zero element;
a query unit, configured to query, in descending order, the residual obtained by means of calculation for an object residual that ranks in the top preset proportion, wherein the preset proportion is determined according to efficiency of topic mining and accuracy of a result of the topic mining; and
a screening unit, configured to determine the object message vector ObjectMₙ corresponding to the object residual from the message vector Mₙ of the non-zero element.

11. The topic mining apparatus according to claim 10, wherein the calculation unit is configured to calculate the residual of the message vector of the non-zero element according to a formula r_{w,d}ⁿ(k)=x_{w,d}|μ_{w,d}ⁿ(k)−μ_{w,d}ⁿ⁻¹(k)|, wherein r_{w,d}ⁿ(k) is the residual of the message vector of the non-zero element, k=1, 2, . . . , K, K is a preset quantity of topics, μ_{w,d}ⁿ(k) is a value of a k^{th} element of a message vector obtained by performing, in the iterative process executed for the n^{th} time, calculation on an element in a w^{th} row and a d^{th} column in the term-document matrix, x_{w,d} is a value of the element in the w^{th} row and the d^{th} column in the term-document matrix, and μ_{w,d}ⁿ⁻¹(k) is a value of a k^{th} element of a message vector obtained by performing, in the iterative process executed for an (n−1)^{th} time, calculation on the element in the w^{th} row and the d^{th} column in the term-document matrix.

12. The topic mining apparatus according to claim 10, wherein the query unit is configured to perform calculation on the residual r_{w,d}ⁿ(k) according to a formula
$${r}_{w}^{n} ( k ) = {\sum }_{d} {r}_{w , d}^{n} ( k ) ,$$
to obtain a cumulative residual matrix, wherein r_{w,d}ⁿ(k) is a value of a k^{th} element, in the iterative process executed for the n^{th} time, of a residual of the message vector of the element in the w^{th} row and the d^{th} column in the term-document matrix, and r_{w}ⁿ(k) is a value of an element, in the iterative process executed for the n^{th} time, in a w^{th} row and a k^{th} column in the cumulative residual matrix; in each row in the cumulative residual matrix, determine, in descending order, a column ρ_{w}ⁿ(k) in which an element that ranks in the top preset proportion λₖ is located, wherein 0<λₖ≦1; accumulate the element determined in each row, to obtain a sum value corresponding to each row; determine a row ρ_{w}ⁿ corresponding to a sum value that ranks in the top preset proportion λ_{w} in descending order, wherein 0<λ_{w}≦1 and λₖ×λ_{w}≠1; and determine a residual r_{ρ}_{_{w}}_{ⁿ}_{,d}ⁿ(ρ_{w}ⁿ(k)) that meets k=ρ_{w}ⁿ(k), w=ρ_{w}ⁿ as the object residual.

13. The topic mining apparatus according to claim 12, wherein the screening unit is configured to determine, from the message vector Mₙ of the non-zero element, the object message vector ObjectMₙ corresponding to the object residual r_{ρ}_{_{w}}_{ⁿ}_{,d}ⁿ(ρ_{w}ⁿ(k)) as μₚ_{_{w}}_{ⁿ}_{,d}ⁿ(ρ_{w}ⁿ(k)).

14. The topic mining apparatus according to claim 11, wherein the update module comprises:
a first update unit, configured to perform calculation according to a formula
$${θ}_{d}^{n} ( k ) = {\sum }_{w} {x}_{w , d} {μ}_{w , d}^{n} ( k ) ,$$
to obtain a value θ_{d}ⁿ(k) of an element in a k^{th} row and a d^{th} column in an updated current document-topic matrix of the LDA model, and update a value of an element in a k^{th} row and a d^{th} column in the current document-topic matrix of the LDA model by using θ_{d}ⁿ(k), wherein k=1, 2, . . . , K, K is a preset quantity of topics, x_{w,d} is a value of the element in the w^{th} row and the d^{th} column in the term-document matrix, and μ_{w,d}ⁿ(k) is a value of the k^{th} element of the message vector obtained by performing, in the iterative process executed for the n^{th} time, calculation on x_{w,d}; and
a second update unit, configured to obtain by means of calculation, according to a formula
$${Φ}_{w}^{n} ( k ) = {\sum }_{d} {x}_{w , d} {μ}_{w , d}^{n} ( k ) {μ}_{w , d}^{n} ( k ) ,$$
a value Φ_{w}ⁿ(k) of an element in a k^{th} row and a w^{th} column in an updated current term-topic matrix of the LDA model, and update a value of an element in a k^{th} row and a w^{th} column in the current term-topic matrix of the LDA model by using Φ_{w}ⁿ(k).

15. The topic mining apparatus according to claim 9, wherein the message vector calculation module is configured to:
in the iterative process executed for the n^{th} time, perform calculation according to a formula
$${μ}_{w , d}^{n} ( k ) ∝ \frac{[ {θ}_{d}^{n - 1} ( k ) + α ] \times [ {Φ}_{w}^{n - 1} ( k ) + β ]}{{\sum }_{w} {Φ}_{w}^{n - 1} ( k ) + W β} ,$$
to obtain a value μ_{w,d}ⁿ(k) of a k^{th} element of the message vector of the element x_{w,d} in the w^{th} row and the d^{th} column in the term-document matrix, wherein k=1, 2, . . . , K, K is a preset quantity of topics, w=1, 2, . . . , W, W is a length of a term list, d=1, 2, . . . , D, D is a quantity of the training documents, θ_{d}ⁿ(k) is a value of an element in a k^{th} row and a d^{th} column in the current document-topic matrix, Φ_{w}ⁿ(k) is a value of an element in a k^{th} row and a w^{th} column in the current term-topic matrix, and α and β are preset coefficients whose value ranges are positive numbers.

16. The topic mining apparatus according to claim 9, wherein the apparatus further comprises:
a determining module, configured to determine an initial message vector μ_{w,d}ⁿ(k) of each non-zero element in the term-document matrix, k=1, 2, . . . , K,
wherein k=1, 2, . . . , K, K is a preset quantity of topics,
$${\sum }_{k} {μ}_{w , d}^{0} ( k ) = 1 ,$$
and μ_{w,d}ⁿ(k)≧0, wherein μ_{w,d}ⁿ(k) is a k^{th} element of the initial message vector of the non-zero element x_{w,d} in the w^{th} row and the d^{th} column in the term-document matrix;
a first obtaining module, configured to calculate the current document-topic matrix according to a formula
$${θ}_{d}^{0} ( k ) = {\sum }_{w} {x}_{w , d} {μ}_{w , d}^{0} ( k ) ,$$
wherein μ_{w,d}ⁿ(k) is the initial message vector, and θ_{d}ⁿ(k) is a value of an element in a k^{th} row and a d^{th} column in the current document-topic matrix; and
a second obtaining module, configured to calculate the current term-topic matrix according to a formula
$${Φ}_{w}^{0} ( k ) = {\sum }_{d} {x}_{w , d} {μ}_{w , d}^{0} ( k ) ,$$
wherein μ_{w,d}ⁿ(k) is the initial message vector, and Φ_{w}ⁿ(k) is a value of an element in a k^{th} row and a w^{th} column in the current term-topic matrix.
